(19) United States
(12) Patent Application Publication
(10) Pub. No.: US 2026/0180174 A1
(43) Pub. Date: Jun. 25, 2026

(54) Generic BFIC Front-end Antenna Tile Assembly

(71) Applicant: THALES, Meudon (FR)

(72) Inventors: James Evan BELLUOT, Vélizy-Villacoublay cedex (FR); Renan LE GALL, Vélizy-Villacoublay cedex (FR); Roger PEREIRA, Vélizy-Villacoublay cedex (FR)

(21) Appl. No.: 19/422,880

(22) Filed: Dec. 17, 2025

(30) Foreign Application Priority Data
Dec. 20, 2024 (FR) FR 24 14923

(51) Int. Cl. H01Q 3/34; H01Q 3/28

(52) U.S. Cl. CPC H01Q 3/34; H01Q 3/28

(57) ABSTRACT

Generic BFIC front-end antenna tile assembly comprising:
a multilayer printed circuit board (1);
a BFIC component (18);
the multilayer printed circuit board (1) comprising:
   at least one RF track (13) and at least one ground track (20), each ending at one end on the internal face of the printed circuit board (1) in a connection 21, and ending at its other end in a connection 22 on the external face of the printed circuit board;
   the RF track(s) (13) and ground track(s) (20) comprising coaxial connections in each layer of the printed circuit board, a coaxial connection ending on each face in a coaxial pad, and microstrip lines to connect two coaxial pads of a track in inter-layers; and
the internal layer (23) of the printed circuit board comprising elementary groupings of one or two coaxial pads arranged according to a regular grid.

The present invention relates to a generic BFIC tile assembly integrating the front-end part of an antenna.

By “front-end” of an antenna, it is meant the part of a receiving or transmitting antenna system that processes signals before their amplification.

The invention is intended for active antennas ranging from the Ku band starting at 10 GHz to microwaves (40 GHz and beyond). It applies to all types of analog beamforming components. It is particularly useful for active antennas when associated with amplification or radiation functions where density and integration constraints are strong.

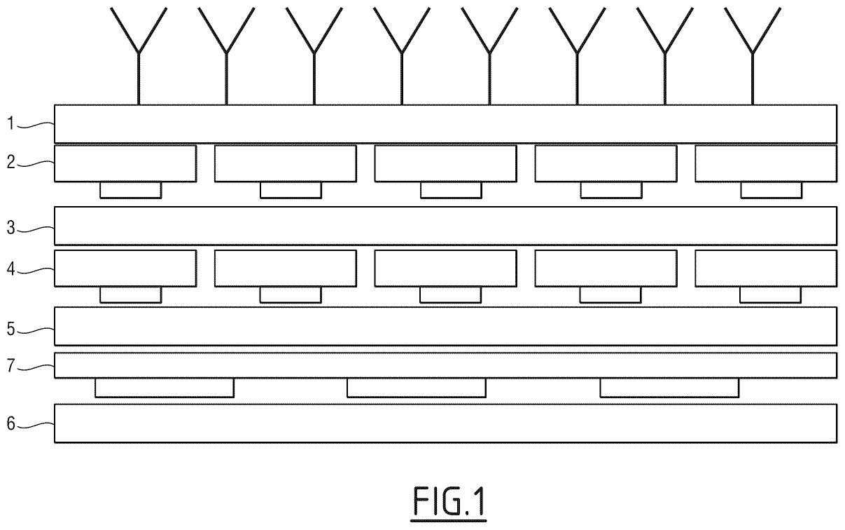

Within the framework of the development of an active antenna front-end, several functional elements must be interconnected, as illustrated in FIG. 1:
an antenna panel 1 (radiating elements: horns, patches, slots . . . );
power or low-noise amplification boards 2;
boards 3 integrating components serving for beamforming called BFIC for “Beam Former Integrated Components”;
a digital board 4 allowing for real-time beamforming management called ACU for “Antenna Control Unit”;
a frequency conversion board 5 allowing to convert RF signals to baseband or vice versa;
a metallic structure 6 for shielding and thermal dissipation;
various interconnection and interfacing elements 7 (electrical, mechanical, and thermal).

The representation in FIG. 1 schematically illustrates an RF front-end concept implementing the elements listed above.

For this assembly to function correctly, it is necessary to be able to associate the BFIC boards with the radiating elements. A simple solution consists of printing the antennas directly on the opposite side of the printed circuit board to the side on which the BFICs are wired. It is also possible to irreversibly bond these elements together by gluing or soldering or to interconnect them by means of RF connectors. Each of these solutions requires designing a specific tile depending on the use case.

In order to limit costs and optimize losses, designers aim to minimize the number of parts and try to share as many functions as possible. It is therefore very common to see BFIC tiles that integrate the BFICs on one side and the patch antennas on the other side. The functions are then inseparable. If, for another application, it is desirable to change the type of radiating element to achieve different performances, the BFIC tile must be specifically redesigned, which is very costly.

Tiles with integrated patch antennas are known. Patch antennas require the implementation of thick substrate layers that do not allow for the realization of symmetrical printed circuit layer stacks, which violates printed circuit design rules and harms their large-scale manufacturability and reliability.

This type of assembly presents significant risks because the different nature of the materials which compose the board and the antenna lead to differential expansion that affects the reliability of the assembly. The two elements, board and antenna panel, are then non-removable, which poses a major repairability problem.

In order to make the radiating elements separable from the BFIC boards, they can be equipped with connectors on the side opposite to the one integrating the BFICs. In this case, it is necessary to have space to integrate a large number of connectors both on the BFIC tiles and on the radiating elements. This proves potentially impossible in cases where the interconnection signal density is high (high frequency). If, despite everything, this proves feasible, this approach is extremely expensive because these connectors are very costly.

In known examples, it is generally complex to align the components during assembly. Furthermore, this type of design is prohibitive from a cost perspective. Transmission losses in connectors for high frequencies are also very significant.

The aim of the invention is to overcome the aforementioned drawbacks, and more particularly to propose a generic BFIC tile for the front-end part of an antenna.

According to one aspect of the invention, a generic BFIC tile assembly for the front-end part of an antenna, said front-end, comprises:
a multilayer printed circuit board;
at least one BFIC component;
solder balls between the BFIC component and the external face of the printed circuit board;
the multilayer printed circuit board comprising:
at least one RF track in the printed circuit board ending at one end on the internal face of the printed circuit board in a coaxial pad, and ending at its other end in a coaxial pad on the external face of the printed circuit board;
at least one ground track in the printed circuit board ending at one end on the internal face of the printed circuit board in a coaxial pad, and ending at its other end on the external face of the printed circuit board in a coaxial pad;
the RF track(s) and ground track(s) comprising coaxial connections in each layer of the printed circuit board, a coaxial connection ending on each face in a coaxial pad, and microstrip lines (or “microstrips” in English), for example of 50Ω impedance, to connect two coaxial pads of a track in inter-layers; and
the internal layer of the printed circuit board comprising elementary groupings of one or two coaxial pads arranged in a regular grid.

In one embodiment, the elementary groupings of one or two coaxial pads are arranged in a regular square grid.

According to one embodiment, the internal layer of the multilayer printed circuit board equipped with coaxial pads is square-shaped.

In one embodiment, the elementary groupings of one or two coaxial pads are arranged in a regular triagonal grid.

By triagonal grid, it is meant a grid in which the elementary groupings of one or two coaxial pads form a triangle, for example isosceles or even equilateral, such a triagonal grid being denser than a rectangular or even square grid.

According to one embodiment, the internal layer equipped with coaxial pads is substantially square-shaped, the opposite sides of which have complementary shapes so that two contiguous tile assemblies can interlock and the arrangement of the pads on the two tiles remains a regular triagonal grid.

In one embodiment, a pitch between two groupings is half the wavelength of the highest frequency of the instantaneous band of the transmitted signal.

According to one embodiment, the printed circuit board comprises, on its internal face, for each coaxial pad, at least one solder ball arranged in the central part of the coaxial pad, and at least two solder balls arranged on the outer periphery of the coaxial pad, to ensure ground contact.

It is also proposed, according to another aspect of the invention, an active antenna comprising:
at least one radiating element;
at least one tile assembly;
at least one interposer arranged between the radiating element and the tile assembly.

In one embodiment, the interposer is a high-frequency coaxial interposer.

According to one embodiment, the high-frequency coaxial interposer comprises a diffuse contact.

The invention will appear more clearly upon reading the following description, given solely by way of non-limiting example, and made with reference to the drawings on which:

FIG. 1 schematically illustrates an RF front-end concept, according to the state of the art;

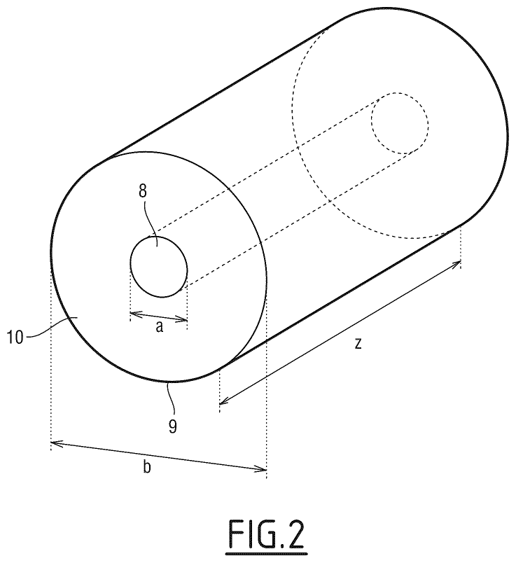

FIG. 2 schematically illustrates a coaxial connection, according to the state of the art;

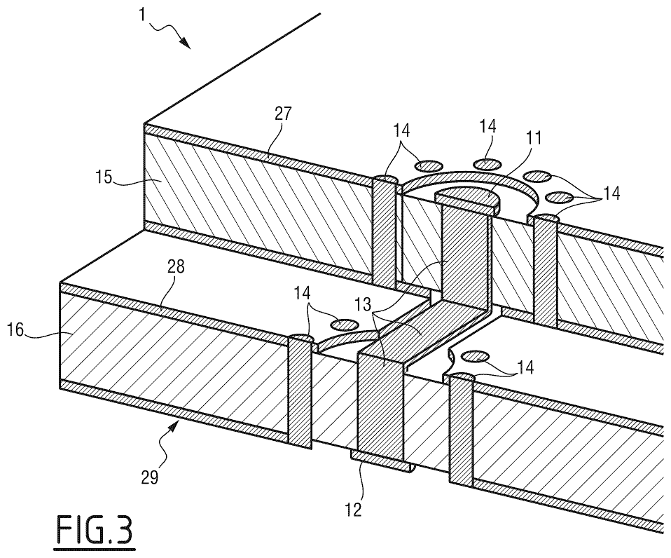

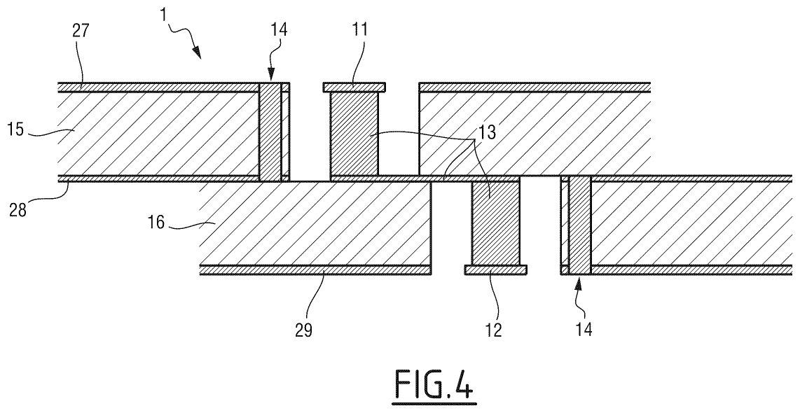

FIG. 3 and FIG. 4 schematically illustrate a coaxial connection, in a multilayer printed circuit board, according to the state of the art;

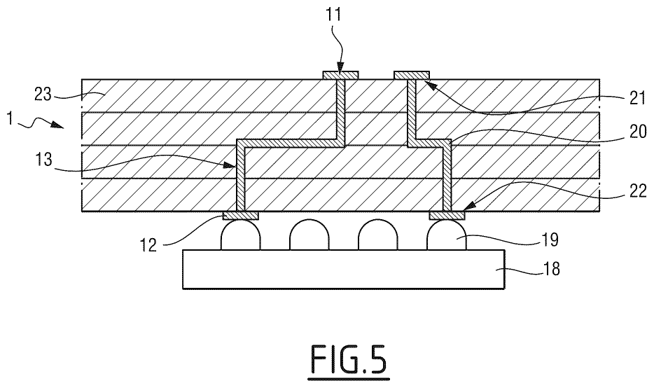

FIG. 5 schematically illustrates a generic BFIC tile assembly for the front-end part of an antenna, according to one aspect of the invention;

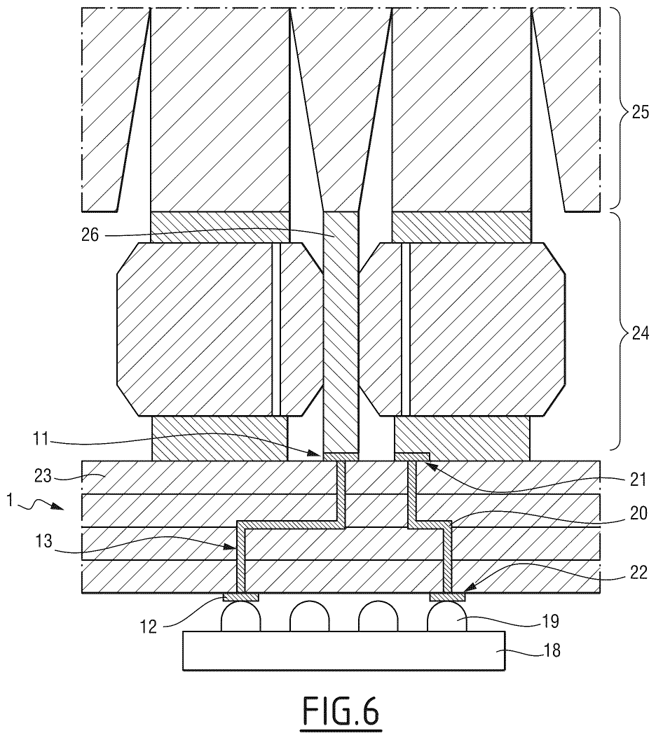

FIG. 6 schematically illustrates an active antenna equipped with at least one generic BFIC tile assembly for the front-end part of an antenna, according to one aspect of the invention;

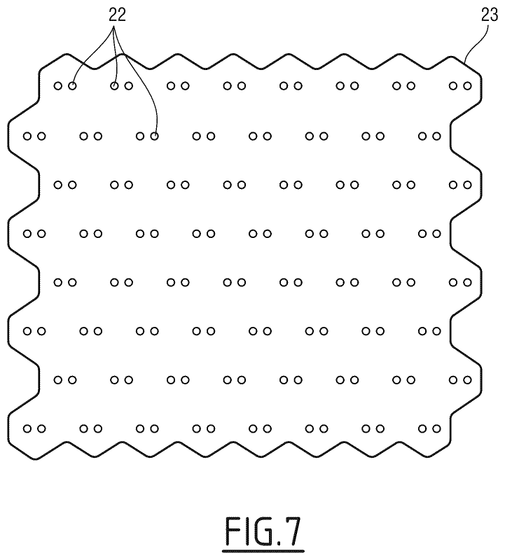

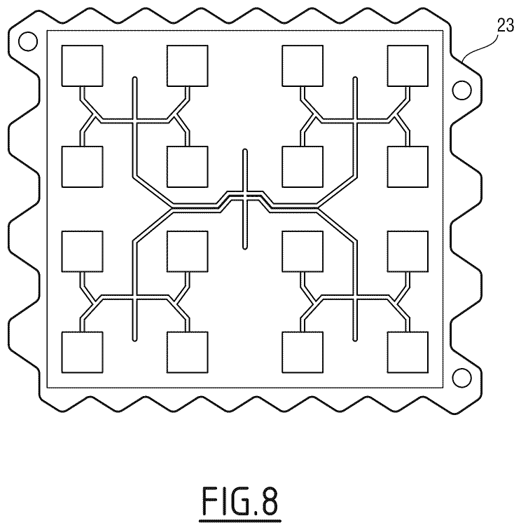

FIG. 7 and FIG. 8 schematically illustrate the two internal and external faces of a generic BFIC tile assembly for the front-end part of an antenna, with elementary groupings of one or two coaxial pads arranged in a regular triagonal grid, according to one aspect of the invention;

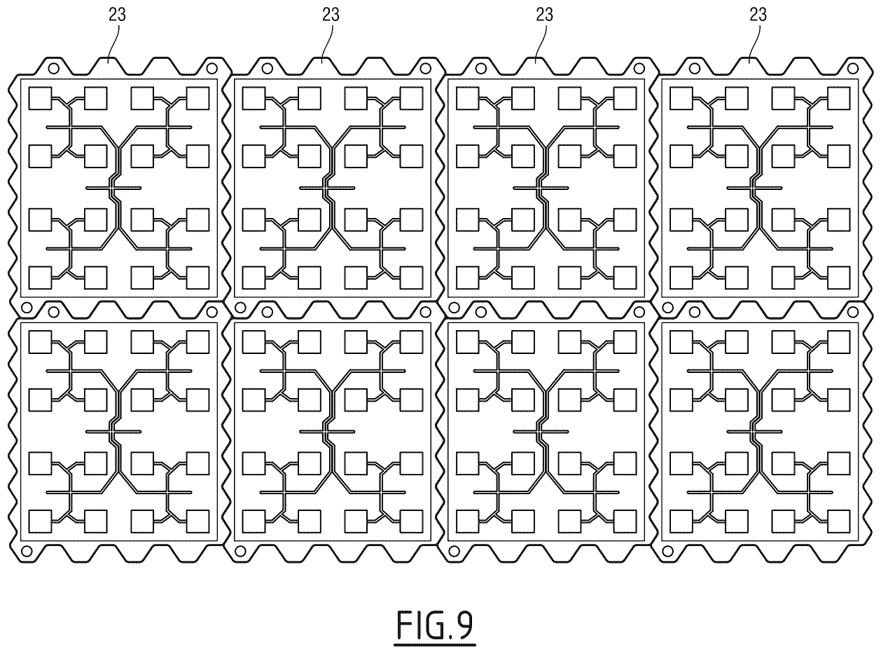

FIG. 9 schematically illustrates a plurality of generic BFIC tile assemblies mounted contiguously on a panel or radiating element, according to one aspect of the invention.

In all the figures, elements having identical references are similar.

FIG. 2 schematically illustrates a coaxial connection, according to the state of the art.

A coaxial connection is constituted of a central conductor 8 of radius a, an external conductor 9 arranged at a distance or radius b from the central axis of the central conductor 8, and an insulator 10 that separates them, called the propagation medium. The propagation medium 10 is characterized by two physical quantities that are the relative permittivity Er and the relative permeability μᵣ. Such a coaxial connection of length z allows the propagation of an electromagnetic wave between the two ends of the connection called input and output. In order that the signal transmission to be optimal in a coaxial connection, it must present a characteristic impedance compatible with that presented by the external elements at its accesses (antenna, amplifier, transmitter, receiver, etc.). This normalized characteristic impedance Z0 depends on the aforementioned physical quantities according to the following law:

$$Z 0 = \sqrt{\frac{{ε}_{r}}{{μ}_{r}}} \times \frac{ln ( \frac{b}{a} )}{2 π} .$$

The normalized characteristic impedance for a coaxial conductor is generally 50Ω. The dimensions a and b are chosen to obtain an impedance of 50Ω for a given material for which εᵣ and μᵣ are known.

A coaxial connection can be formed by a cable (for example, copper wire coated with Teflon, all coated with metal) or by two pads on a printed circuit board connected by a via.

As illustrated in FIG. 3 and FIG. 4, a pad 11, 12 is a copper island isolated from the rest of the copper plane 27, 28, 29 on the surface of a multilayer printed circuit board 1, also called ground plane. Such a pad 11, 12 constitutes a contact reception area with an element, external to the printed circuit board such as the central conductor of a connector. Two pads 11, 12 placed on either side of the multilayer printed circuit board 1, connected by a via 13, form a central conductor.

The substrate or material that composes the printed circuit board constitutes the propagation medium. The three previously described elements 11, 12, 13 form a coaxial connection the characteristic impedance of which can reach 50 Ω if the geometries (a and b) are correctly chosen.

The structure of the multilayer printed circuit board 1 allows to interconnect signals that are not face-to-face. To do this, each layer 15, 16 of the printed circuit board 1, the example illustrated in FIG. 3 and FIG. 4 having only two layers 15, 16, in a non-limiting manner, integrates a coaxial connection. The two coaxial connections are connected to each other in inter-layers through the microstrip line 13 of 50Ω impedance (5). It is then possible to connect the pads present on one face of the printed circuit board 11 to electronic components, for example by soldering. It is also possible to connect the pads 12 of the opposite face to a connector or an interconnection system such as an interposer that can be connected to an antenna, for example a flexible interposer.

Two ground planes from among the ground planes 27, 28, and 29, located around a pad 11, 12 and on either side of the layers 15, 16 connected by crowns of conductive vias 14 the spacing of which is less than λ/10, form an external conductor of FIG. 2.

Also, it is possible to connect the inputs or outputs of electronic components to an external interconnection system the accesses of which are not face-to-face.

In other words, as illustrated in FIG. 5, the invention relates to a generic BFIC tile assembly for the front-end part of an antenna, said front-end, comprising:
a multilayer printed circuit board 1;
at least one BFIC component 18;
solder balls 19 between the BFIC component 18 and the external face of the printed circuit board 1;
the multilayer printed circuit board 1 comprising:
   at least one RF track 13 in the printed circuit board 1 ending at one end on the internal face of the printed circuit board 1 in a coaxial pad 11, and ending at its other end in a coaxial pad 12 on the external face of the printed circuit board 1;
   at least one ground track 20 in the printed circuit board 1 ending at one end on the internal face of the printed circuit board 1 in a coaxial pad 21, and ending at its other end on the external face of the printed circuit board 1 in a coaxial pad 22;
   the RF tracks 13 and the ground tracks 20 comprising coaxial connections in each layer of the printed circuit board, a coaxial connection ending on each face in a coaxial pad, and microstrip lines of 50Ω impedance to connect two coaxial pads of a track in inter-layers; and
   the internal layer 23 of the printed circuit board comprising elementary groupings of one or two coaxial pads arranged according to a regular grid.

The elementary groupings of one or two coaxial pads can be arranged according to a regular square grid, and the internal layer of the multilayer printed circuit board 1 with coaxial pads can be square-shaped.

The elementary groupings of one or two coaxial pads are arranged according to a regular triagonal grid, and the internal layer 23 equipped with coaxial pads is substantially square-shaped, with opposite sides having complementary shapes so that two contiguous tile assemblies can interlock and the arrangement of the pad groupings on the two tiles forms a regular triagonal grid.

FIG. 6 represents an example of use in an active antenna with an interposer 24, and a radiating element 25. The interposer 24 can be a high-frequency coaxial interposer, for example comprising a diffuse contact 26.

The BFIC components integrate several inputs and/or outputs the main function of which is to amplify an incoming or outgoing signal while varying its phase and amplitude so that the signals, when radiated through an antenna, can combine in space: this is called spatial combination. By controlling the phase of the BFIC components, it is also possible to perform a scan of the combination point: this is called electronic scanning.

It is possible to interconnect several BFIC components wired on the same external face of the printed circuit board 1 to several pads of the opposite internal face without the accesses being face-to-face (offset). This characteristic is important because in order for the spatial combination device to work, it is necessary for the radiating elements to form a grid each unit element of which is spaced at most a half a wavelength A (this is called an antenna array). The wavelength λ is proportional to the inverse of the operating frequency according to the formula λ=c/f in which c represents the speed of light and f represents the maximum operating frequency.

The different inputs and/or outputs of a BFIC component are not spaced at the same pitch as that of the antenna array, it is usually necessary to resort to offset coaxial connectors thanks to the multilayer circuit.

A printed circuit board the spacing of which between pads of the coaxial connections located on the antenna side respects the grid relative to the half wavelength (λ/2) of the highest frequency of the instantaneous band of the transmitted signal allows for spatial combination to be carried out at the board level. The grid can be triagonal or square.

Such a board is called an elementary board or generic beamforming tile.

A complete antenna panel includes several elementary beamforming boards arranged contiguously such that the spacing between pads located on either side of two adjacent boards remains constant. When this condition is met, the elementary beamforming board is more precisely called a generic BFIC tile.

As illustrated in FIG. 7, in the case of a triagonal grid, the internal layer 23 of the generic tile equipped with coaxial pads 22 is substantially square-shaped, the opposite sides of which have complementary shapes so that two contiguous tile assemblies can interlock and the arrangement of the groupings of the pads on the two tiles forms a regular triagonal grid.

The complementary shapes of the opposite sides can take any form provided that the pads remain equidistant from board to board to maintain a uniform pattern.

FIG. 8 schematically represents the other face of a generic BFIC tile assembly.

FIG. 9 schematically represents a plurality of generic BFIC tile assemblies mounted contiguously on the panel or radiating element 25.

The present invention allows:
to ensure repair or replacement of the board because the tile is separable from the radiating element;
to produce large quantities of parts at target cost because these tiles are not integrated into RF connectors;
to have a unique design able to be associated with any type of antenna or radiating element (patch, slot, 3D additive . . . ). This allows to achieve different antenna performances from the same generic brick (BFIC tile) without costly and time-consuming new design;
to present a symmetrical PCB structure allowing to avoid bending or warping effects during passage through reflow oven. It is also possible to handle larger board formats, therefore more economical. Indeed, if the board incorporates patch antennas, the PCB structure will necessarily be asymmetrical; and
to automatically test each RF path in series conventionally without resorting to radiation testing means in an anechoic chamber (a simple vector network analyzer is sufficient).

The present invention allows:
to assemble several types of radiating panels of different technologies with a single and same version of the tile: several antenna performances achievable from the same tile allowing to save valuable design time;
to produce, in large quantities, thanks to its layer stacking structure of symmetrical tile circuits usable for multiple applications without costly specific design efforts; and
to produce a low-cost tile because RF connectors are excluded from the tile
to produce a repairable tile when assembled with a flexible interposition device thanks to the compatible interconnection area of the flexible interposition device.

1. A generic BFIC front-end antenna tile assembly, said front-end, comprising:
a multilayer printed circuit board;
at least one BFIC component;
solder balls between the BFIC component and the external face of the printed circuit board;
the multilayer printed circuit board comprising:
at least one RF track in the printed circuit board ending at one end on the internal face of the printed circuit board in a connection, and ending at its other end in a connection on the external face of the printed circuit board;
at least one ground track in the printed circuit board ending at one end on the internal face of the printed circuit board in a connection, and ending at its other end on the external face of the printed circuit board in a connection;
the RF track(s) and ground track(s) comprising coaxial connections in each layer of the printed circuit board, a coaxial connection ending on each face in a coaxial pad, and microstrip lines to connect two coaxial pads of a track in inter-layers; and
the internal layer of the printed circuit board comprising elementary groupings of one or two coaxial pads arranged according to a regular grid.

2. The generic BFIC tile assembly according to claim 1, wherein the elementary groupings of one or two coaxial pads are arranged according to a regular square grid.

3. The generic BFIC tile assembly according to claim 2, wherein the internal layer of the multilayer printed circuit board equipped with coaxial pads is square-shaped.

4. The generic BFIC tile assembly according to claim 1, wherein the elementary groupings of one or two coaxial pads are arranged in a regular triagonal grid.

5. The generic BFIC tile assembly according to claim 4, wherein the internal layer equipped with coaxial pads is substantially square-shaped, the opposite sides of which have complementary shapes so that two contiguous tile assemblies can interlock and the arrangement of the pad groupings on the two tiles forms a regular triagonal grid.

6. The generic BFIC tile assembly according to claim 1, wherein a pitch between two groupings is half the wavelength of the highest frequency of the instantaneous band of the transmitted signal.

7. The generic BFIC tile assembly according to claim 1, wherein the printed circuit board comprises on its internal face, for each coaxial pad, at least one solder ball arranged in the central part of the coaxial pad, and at least two solder balls arranged on the outer periphery of the coaxial pad.

8. An active antenna comprising:
at least one radiating element;
at least one tile assembly according to claim 1;
at least one interposer arranged between the radiating element and the tile assembly.

9. The active antenna according to claim 8, wherein the interposer is a high-frequency coaxial interposer.

10. The active antenna according to claim 9, wherein the high-frequency coaxial interposer comprises a diffuse contact.
